(19) United States
(12) Patent Application Publication
(10) Pub. No.: US 2026/0282090 A1
(43) Pub. Date: Sep. 17, 2026

(54) ACCESS POINT AND APPARATUS USED THEREIN

(71) Applicant: Intel Corporation, Santa Clara, CA (US)

(72) Inventors: Laurent Cariou, Milizac (FR); Dmitry Akhmetov, Hillsboro, OR (US); Dibakar Das, Hillsboro, OR (US)

(21) Appl. No.: 19/479,992

(22) PCT Filed: Mar. 29, 2024
(86) PCT No.: PCT/US2024/022112

§ 371 Date: Oct. 29, 2025

Related U.S. Application Data
(60) Provisional application No. 63/507,628, filed on Jun. 12, 2023.

(51) Int. Cl. H04W 74/0816

(52) U.S. Cl. CPC H04W 74/0816

(57) ABSTRACT

The application relates to an Access Point (AP) and an apparatus used therein, wherein the apparatus includes processor circuitry configured to cause the AP to: receive, from a sharing AP, a Single User Trigger Frame (SU-TF), wherein the SU-TF is used to allocate time within a Transmission Opportunity (TXOP) of the sharing AP to multiple communication stations including the AP and includes a Duration field indicating a competition allowed duration in which only the multiple communication stations are allowed to contend for a communication channel; and send, to the sharing AP, a Clear To Send (CTS) frame upon receiving the SU-TF and before contending for a communication channel, wherein the CTS frame comprises a Receiver Address (RA) field set to a Media Access Control (MAC) address of the sharing AP.

### CROSS REFERENCES TO RELATED APPLICATIONS

This application is based on and claims priority to U.S. patent application No. 63/507,628 filed on Jun. 12, 2023, which is incorporated herein by reference in its entirety.

### TECHNICAL FIELD

Embodiments of the disclosure generally relate to wireless communications, and in particular, to an Access Point (AP) and an apparatus used in the AP.

### BACKGROUND

Wireless devices are becoming widely prevalent and are increasingly requesting access to wireless channels. The Institute of Electrical and Electronics Engineers (IEEE) is developing one or more standards that utilize Orthogonal Frequency-Division Multiple Access (OFDMA) in channel allocation.

### SUMMARY

An aspect of the disclosure provides an apparatus used in an AP, wherein the apparatus includes processor circuitry configured to cause the AP to: receive, from a sharing AP, a Single User Trigger Frame (SU-TF), wherein the SU-TF is used to allocate time within a Transmission Opportunity (TXOP) of the sharing AP to multiple communication stations including the AP and includes a Duration field indicating a competition allowed duration in which only the multiple communication stations are allowed to contend for a communication channel; and send, to the sharing AP, a Clear To Send (CTS) frame upon receiving the SU-TF and before contending for a communication channel, wherein the CTS frame includes a Receiver Address (RA) field set to a Media Access Control (MAC) address of the sharing AP.

### BRIEF DESCRIPTION OF THE DRAWINGS

Embodiments of the disclosure will be illustrated, by way of example and not limitation, in the figures of the accompanying drawings in which like reference numerals refer to similar elements.

FIG. 1 is a network diagram of an example network environment in accordance with some embodiments of the disclosure.

FIG. 2A is a flow diagram of a method used in an AP supporting the C-TDMA mode in accordance with some embodiments of the disclosure.

FIG. 2B is a diagram of an example C-TDMA application scenario in accordance with some embodiments of the disclosure.

FIG. 2C is a diagram of an example C-TDMA application scenario in accordance with some embodiments of the disclosure.

FIG. 2D is a diagram of an example C-TDMA application scenario in accordance with some embodiments of the disclosure.

FIG. 2E is a diagram of an example C-TDMA application scenario in accordance with some embodiments of the disclosure.

FIG. 2F is a diagram of an example C-TDMA application scenario in accordance with some embodiments of the disclosure.

FIG. 3 is a functional block diagram of an exemplary communication station in accordance with some embodiments of the disclosure.

FIG. 4 is a functional block diagram of an example of a machine or system upon which any one or more of the techniques (e.g., methodologies) discussed herein may be performed.

FIG. 5 is a functional block diagram of a radio architecture in accordance with some embodiments of the disclosure that may be implemented in any one of APs and/or user devices of FIG. 1.

FIG. 6 is a functional block diagram of WLAN FEM circuitry in accordance with some embodiments of the disclosure.

FIG. 7 is a functional block diagram of radio IC circuitry in accordance with some embodiments of the disclosure.

FIG. 8 is a functional block diagram of baseband processing circuitry in accordance with some embodiments of the disclosure.

### DETAILED DESCRIPTION

Various aspects of the illustrative embodiments will be described using terms commonly employed by those skilled in the art to convey the substance of the disclosure to others skilled in the art. However, it will be apparent to those skilled in the art that many alternate embodiments may be practiced using portions of the described aspects. For purposes of explanation, specific numbers, materials, and configurations are set forth in order to provide a thorough understanding of the illustrative embodiments. However, it will be apparent to those skilled in the art that alternate embodiments may be practiced without the specific details. In other instances, well known features may have been omitted or simplified in order to avoid obscuring the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrases “in an embodiment” “in one embodiment” and “in some embodiments” are used repeatedly herein. The phrase generally does not refer to the same embodiment; however, it may. The terms “comprising,” “having,” and “including” are synonymous, unless the context dictates otherwise. The phrases “A or B” and “A/B” mean “(A), (B), or (A and B).”

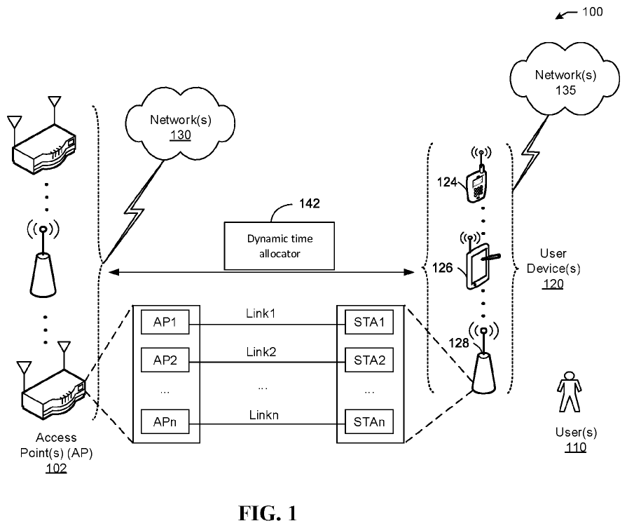

FIG. 1 is a network diagram illustrating an example network environment of NAV protection, according to some example embodiments of the present disclosure. Wireless network 100 may include one or more user devices 120 and one or more access points(s) (AP) 102, which may communicate in accordance with IEEE 802.11 communication standards. The user device(s) 120 may be mobile devices that are non-stationary (e.g., not having fixed locations) or may be stationary devices.

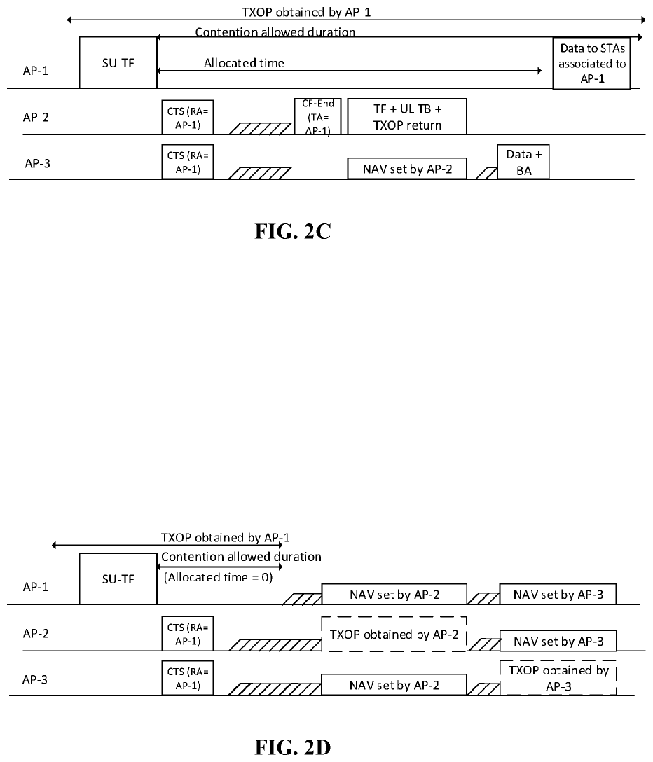

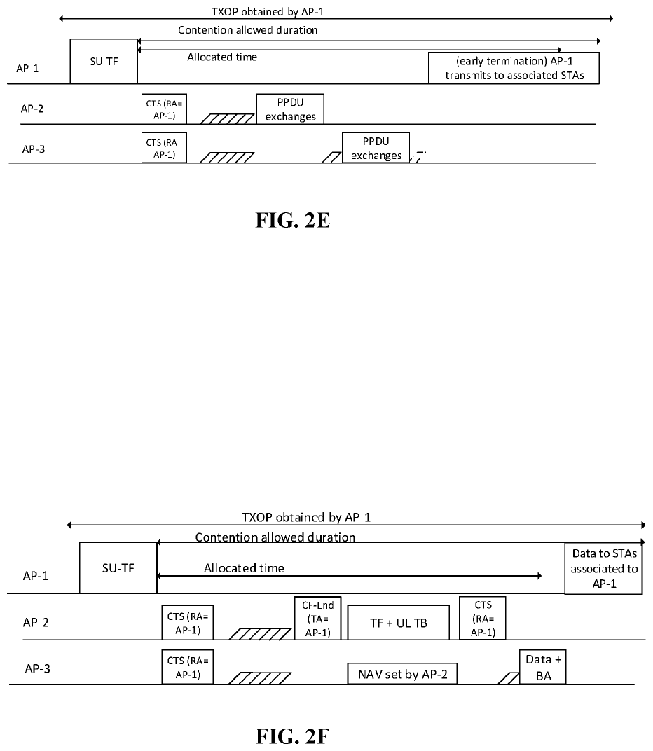

In some embodiments, the user devices 120 and the AP 102 may include one or more computer systems similar to that of the functional diagram of FIG. 3 and/or the example machine/system of FIG. 4.

One or more illustrative user device(s) 120 and/or AP(s) 102 may be operable by one or more user(s) 110. It should be noted that any addressable unit may be a station (STA). An STA may take on multiple distinct characteristics, each of which shape its function. For example, a single addressable unit might simultaneously be a portable STA, a quality-of-service (QOS) STA, a dependent STA, and a hidden STA. The one or more illustrative user device(s) 120 and the AP(s) 102 may be STAs. The one or more illustrative user device(s) 120 and/or AP(s) 102 may operate as a personal basic service set (PBSS) control point/access point (PCP/AP). The user device(s) 120 (e.g., 124, 126, or 128) and/or AP(s) 102 may include any suitable processor-driven device including, but not limited to, a mobile device or a non-mobile, e.g., a static device. For example, the user device(s) 120 and/or AP(s) 102 may include, a user equipment (UE), a station (STA), an access point (AP), a software enabled AP (SoftAP), a personal computer (PC), a wearable wireless device (e.g., bracelet, watch, glasses, ring, etc.), a desktop computer, a mobile computer, a laptop computer, an ultrabook™ computer, a notebook computer, a tablet computer, a server computer, a handheld computer, a handheld device, an internet of things (IOT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. Other devices, including smart devices such as lamps, climate control, car components, household components, appliances, etc. may also be included in this list.

As used herein, the term “Internet of Things (IOT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

The user device(s) 120 and/or AP(s) 102 may also include mesh stations in, for example, a mesh network, in accordance with one or more IEEE 802.11 standards and/or 3GPP standards.

Any of the user device(s) 120 (e.g., user devices 124, 126, 128) and AP(s) 102 may be configured to communicate with each other via one or more communications networks 130 and/or 135 wirelessly or wired. The user device(s) 120 may also communicate peer-to-peer or directly with each other with or without the AP(s) 102. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 120 (e.g., user devices 124, 126, 128) and AP(s) 102 may include one or more communications antennas. The one or more communications antennas may be any suitable type of antennas corresponding to the communications protocols used by the user device(s) 120 (e.g., user devices 124, 126 and 128) and AP(s) 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the user devices 120 and/or AP(s) 102.

Any of the user device(s) 120 (e.g., user devices 124, 126, 128) and AP(s) 102 may be configured to perform directional transmission and/or directional reception in conjunction with wirelessly communicating in a wireless network. Any of the user device(s) 120 (e.g., user devices 124, 126, 128) and AP(s) 102 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the user device(s) 120 (e.g., user devices 124, 126, 128) and AP(s) 102 may be configured to perform any given directional transmission towards one or more defined transmit sectors. Any of the user device(s) 120 (e.g., user devices 124, 126, 128) and AP(s) 102 may be configured to perform any given directional reception from one or more defined receive sectors.

MIMO beamforming in a wireless network may be accomplished using RF beamforming and/or digital beamforming. In some embodiments, in performing a given MIMO transmission, the user devices 120 and/or AP(s) 102 may be configured to use all or a subset of its one or more communications antennas to perform MIMO beamforming.

Any of the user devices 120 (e.g., user devices 124, 126, 128) and AP(s) 102 may include any suitable radio and/or transceiver for transmitting and/or receiving radio frequency (RF) signals in the bandwidth and/or channels corresponding to the communications protocols utilized by any of the user device(s) 120 and AP(s) 102 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g. 802.11b, 802.11g, 802.11n, 802.11ax), 5 GHz channels (e.g. 802.11n, 802.11ac, 802.11ax, 802.11be, etc.), 6 GHz channels (e.g., 802.11ax, 802.11be, etc.), or 60 GHZ channels (e.g. 802.11ad, 802.11ay). 800 MHz channels (e.g. 802.11ah). The communications antennas may operate at 28 GHz and 40 GHz. It should be understood that this list of communication channels in accordance with certain 802.11 standards is only a partial list and that other 802.11 standards may be used (e.g., Next Generation Wi-Fi, or other standards). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

In some embodiments, with reference to FIG. 1, a user device 120 may be in communication with one or more APs 102. For example, one or more APs 102 may implement a dynamic time allocation 142 with one or more user devices 120. The one or more APs 102 may be multi-link devices (MLDs) and the one or more user devices 120 may be non-AP MLDs. Each of the one or more APs 102 may include a plurality of individual APs (e.g., AP1, AP2, . . . , APn, where n is an integer) and each of the one or more user devices 120 may include a plurality of individual STAs (e.g., STA1, STA2, . . . , STAn). The AP MLDs and the non-AP MLDs may set up one or more links (e.g., Link1, Link2, . . . , Linkn) between each of the individual APs and STAs. It is understood that the above descriptions are for purposes of illustration and are not meant to be limiting.

Wi-Fi 8 (i.e., IEEE 802.11bn or Ultra High Reliability (UHR)) standard is the next generation of Wi-Fi standard and a successor to IEEE 802.11be (Wi-Fi 7) standard. In line with all previous Wi-Fi standards, Wi-Fi 8 standard will aim to improve wireless performance in general along with introducing new and innovative features to further advance Wi-Fi technology.

In a UHR wireless communication network, it is expected that a sharing AP may allocate time within its TXOP to multiple STAs so that they can use Enhanced Distributed Channel Access (EDCA) based contention during at least part of the allocated time. As a result, it is proposed to add a Contention-based Time-Division Multiple Access (C-TDMA) mode where the sharing AP would signal in a SU-TF a time allocation and the set of STAs that can perform EDCA based contention within the allocated time.

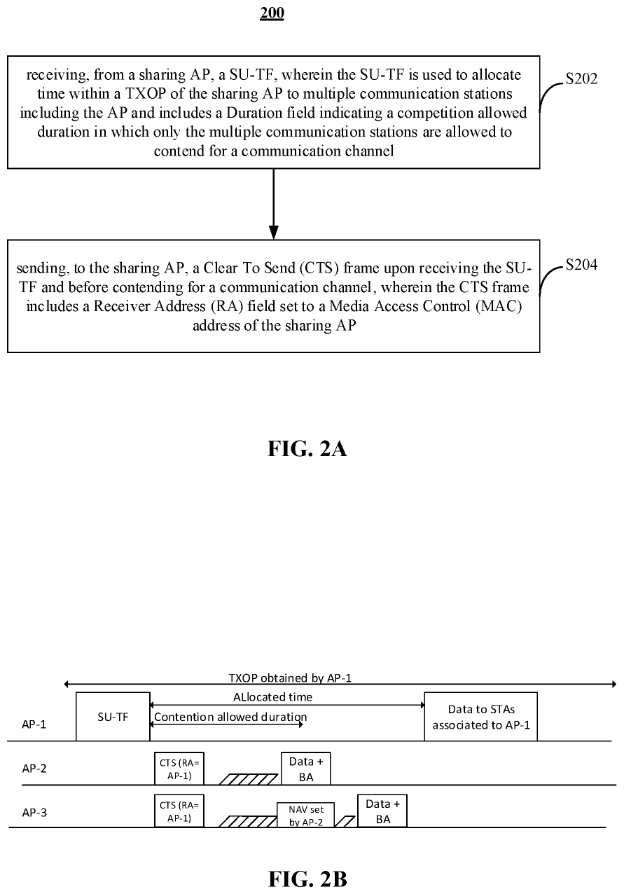

FIG. 2A is a flow diagram of a method used in an AP supporting the C-TDMA mode in accordance with some embodiments of the disclosure. As shown in FIG, 2A, the method 200 used in the AP supporting the C-TDMA mode includes: S202, receiving, from a sharing AP, a SU-TF, wherein the SU-TF is used to allocate time within a TXOP of the sharing AP to multiple communication stations including the AP and includes a Duration field indicating a competition allowed duration in which only the multiple communication stations are allowed to contend for a communication channel; and S204, sending, to the sharing AP, a Clear To Send (CTS) frame upon receiving the SU-TF and before contending for a communication channel, wherein the CTS frame includes a Receiver Address (RA) field set to a Media Access Control (MAC) address of the sharing AP.

In some embodiments, when the contention allowed duration is set to end before the allocated time for the multiple communication stations ends, before the competition allowed duration ends, the method 200 used in the AP supporting the C-TDMA mode further includes: contending, with at least one communication station other than the AP among the multiple communication stations, for the communication channel; and when the AP gains access to the communication channel, sending, to a non-AP STA associated with the AP, a data frame via the communication channel, and receiving, from the non-AP STA associated with the AP, a Block Acknowledgement (BA) frame via the communication channel.

In some embodiments, when the contention allowed duration is set to end before the allocated time for the multiple communication stations ends, after the competition allowed duration ends, the method 200 used in the AP supporting the C-TDMA mode further includes: when the SU-TF is addressed to the AP, gaining access to the communication channel without competition after a Network Allocation Vector (NAV) set by a communication station, which previously gains access to the communication channel, among the multiple communication stations expires and before the allocated time for the multiple communication stations ends; sending, to the non-AP STA associated with the AP, the data frame via the communication channel; and receiving, from the non-AP STA associated with the AP, the BA frame via the communication channel.

FIG. 2B is a diagram of an example C-TDMA application scenario in accordance with some embodiments of the disclosure. As shown in FIG. 2B, AP-1 acts as the sharing AP to allocate time within its TXOP to AP-2 and AP-3 by sending the SU-TF to AP-2 and AP-3; each of AP-2 and AP-3 sends the CTS frame to AP-1 upon receiving the SU-TF and before contending for the communication channel; the competition allowed duration is set to end before the allocated time for AP-2 and AP-3 ends; before the competition allowed duration ends, AP-2 gains access to the communication channel by for example, EDCA based competition, sends the data frame to the non-AP STA associated with AP-2, and receives the BA frame from the non-AP STA associated with AP-2; after the competition allowed duration ends, as the SU-TF is addressed to AP-3, AP-3 gains access to the communication channel without competition after the NAV set by AP-2 expires and before the allocated time for AP-2 and AP-3 ends, sends the data frame to the non-AP STA associated with AP-3, and receives the BA frame from the non-AP STA associated with AP-3.

In some embodiments, when the contention allowed duration is set to last until the TXOP of the sharing AP ends, before the allocated time for the multiple communication stations ends, the method 200 used in the AP supporting the C-TDMA mode further includes: contending, with at least one communication station other than the AP among the multiple communication stations, for the communication channel; broadcasting a Contention-Free End (CF-End) frame to set a NAV when it is the first communication station among the multiple communication stations to gain access to the communication channel, wherein the CF-End frame includes a RA field set to the MAC address of the sharing AP; during the NAV set by the AP, sending, to the non-AP STA associated with the AP, a trigger frame via the communication channel; receiving, from the non-AP STA associated with the AP, a Trigger Based Physical Layer (PHY) Protocol Data Unit (TB PPDU) via the communication channel; and returning unused time within the allocated time for the multiple communication stations for use by at least one communication station other than the AP among the multiple communication stations.

In some embodiments, when the contention allowed duration is set to last until the TXOP of the sharing AP ends, before the allocated time for the multiple communication stations ends, the method 200 used in the AP supporting the C-TDMA mode further includes: contending, with at least one communication station other than the AP among the multiple communication stations, for the communication channel after the NAV set by the communication station, which previously gains access to the communication channel, among the multiple communications expires; and when the AP gains access to the communication channel, sending, to the non-AP STA associated with the AP, the data frame via the communication channel, and receiving, from the non-AP STA associated with the AP, the BA frame via the communication channel.

FIG. 2C is a diagram of an example C-TDMA application scenario in accordance with some embodiments of the disclosure. As shown in FIG. 2C, AP-1 acts as the sharing AP to allocate time within its TXOP to AP-2 and AP-3 by sending the SU-TF to AP-2 and AP-3; each of AP-2 and AP-3 sends the CTS frame to AP-1 upon receiving the SU-TF and before contending for the communication channel; the competition allowed duration is set to last until the TXOP of the sharing AP ends; AP-2 firstly gains access to the communication channel by for example, EDCA based competition, broadcasts the CF-End frame including the RA field set to the MAC address of the AP-1, sends the trigger frame to the non-AP STA associated with AP-2 via the communication channel, receives the TB PPDU from the non-AP STA associated with AP-2 via the communication channel, and returns unused time within the allocated time for AP-2 and AP-3 for use by AP-3; then, AP-3 gains access to the communication channel by for example, EDCA based competition after the NAV set by AP-2 expires, sends the data frame to the non-AP STA associated with AP-3 via the communication channel, and receives the BA frame from the non-AP STA associated with AP-3 via the communication channel.

In some embodiments, when the allocated time for the multiple communication stations is set to zero, before the competition allowed duration ends, the method 200 used in the AP supporting the C-TDMA mode further includes: contending, with at least one communication station other than the AP among the multiple communication stations, for the communication channel; when the AP gains access to the communication channel, obtaining its own TXOP by setting a NAV.

In some embodiments, when the allocated time for the multiple communication stations is set to zero, after the competition allowed duration ends, the method 200 used in the AP supporting the C-TDMA mode further includes: when the SU-TF is addressed to the AP, gain access to the communication channel without competition and obtain its own TXOP by setting a NAV after the NAV set by the communication station, which previously wins the communication channel, among the multiple communications expires.

FIG. 2D is a diagram of an example C-TDMA application scenario in accordance with some embodiments of the disclosure. As shown in FIG. 2D, AP-1 acts as the sharing AP to allocate time within its TXOP to AP-2 and AP-3 by sending the SU-TF to AP-2 and AP-3; each of AP-2 and AP-3 sends the CTS frame to AP-1 upon receiving the SU-TF and before contending for the communication channel; the allocated time for AP-2 and AP-3 is set to zero; before the competition allowed duration ends, AP-2 firstly gains access to the communication channel by for example, EDCA based competition, and obtains its own TXOP by setting a NAV; after the competition allowed duration ends, as the SU-TF is addressed to AP-3, AP-3 gains access to the communication channel without competition after the NAV set by AP-2 expires, and obtains its own TXOP by setting a NAV.

In some embodiments, when the contention allowed duration is set to last until the TXOP of the sharing AP ends, before the allocated time for the multiple communication stations ends, the method 200 used in the AP supporting the C-TDMA mode further includes: contending, with at least one communication station other than the AP among the multiple communication stations, for the communication channel; and when the AP gains access to the communication channel, performing PPDU exchanges with the non-AP STA associated with the AP via the communication channel. In this case, the sharing AP may maintain an inactivity timer, start counting down the inactivity timer upon receiving the CTS frame, pause counting down the inactivity timer whenever detecting the communication channel to be used, and regain access to the communication channel when the inactivity timer expires (i.e., early termination of the allocated time for the multiple communication devices), wherein an initial value of the inactivity timer may be set to an estimated remaining backoff duration for the multiple communication stations. For example, the sharing AP determines whether the communication channel is being used currently using one or more of the following checks: explicit return of TXOP from all communication devices that it tracked to have started transmitting any PPDU within the allocated time for the multiple communication devices; end of any NAV set by all the multiple communication devices, Energy Detection (ED) check potentially using a lower Clear Channel Assessment (CCA)-ED threshold.

FIG. 2E is a diagram of an example C-TDMA application scenario in accordance with some embodiments of the disclosure. As shown in FIG. 2E, AP-1 acts as the sharing AP to allocate time within its TXOP to AP-2 and AP-3 by sending the SU-TF to AP-2 and AP-3; each of AP-2 and AP-3 sends the CTS frame to AP-1 upon receiving the SU-TF and before contending for the communication channel; the contention allowed duration is set to last until the TXOP of the sharing AP ends; AP-2 and AP-3 successively gain access to the communication channel by for example, EDCA based competition, and perform PPDU exchanges with the non-AP STA associated therewith via the communication channel; before the allocated time for AP-2 and AP-3 ends, AP-1 regains access to the communication channel.

In some embodiments, when the contention allowed duration is set to last until the TXOP of the sharing AP ends, before the allocated time for the multiple communication stations ends, the method 200 used in the AP supporting the C-TDMA mode further includes: contending, with at least one communication station other than the AP among the multiple communication stations, for the communication channel; broadcasting the CF-End frame to set a NAV when it is the first communication station among the multiple communication stations to gain access to the communication channel, wherein the CF-End frame includes the RA field set to the MAC address of the sharing AP; during the NAV set by the AP, sending, to the non-AP STA associated with the AP, the trigger frame via the communication channel; receiving, from the non-AP STA associated with the AP, the TB PPDU via the communication channel; and sending, to the sharing AP, another CTS frame after receiving the TB PPDU, wherein the another CTS frame comprises the RA field set to the MAC address of the sharing AP.

FIG. 2F is a diagram of an example C-TDMA application scenario in accordance with some embodiments of the disclosure. As shown in FIG. 2F, AP-1 acts as the sharing AP to allocate time within its TXOP to AP-2 and AP-3 by sending the SU-TF to AP-2 and AP-3; each of AP-2 and AP-3 sends the CTS frame to AP-1 upon receiving the SU-TF and before contending for the communication channel; the contention allowed duration is set to last until the TXOP of the sharing AP ends; AP-2 firstly gains access to the communication channel by for example, EDCA based competition, broadcasts the CF-End frame including the RA field set to the MAC address of the AP-1, sends the trigger frame to the non-AP STA associated with AP-2 via the communication channel, receives the TB PPDU from the non-AP STA associated with AP-2 via the communication channel, and then sends another CTS frame to AP-1, so that all non-AP STAs associated with AP-2 set their NAV based on the another CTS frame, and AP-3 is only blocked by the NAV set by AP-2; then, AP-3 gains access to the communication channel by for example, EDCA based competition after the NAV set by AP-2 expires, sends the data frame to the non-AP STA associated with AP-3 via the communication channel, and receives the BA frame from the non-AP STA associated with AP-3 via the communication channel.

FIG. 3 shows a functional diagram of an exemplary communication station, in accordance with one or more example embodiments of the disclosure. In one embodiment, FIG. 3 illustrates a functional block diagram of a communication station 300 that may be suitable for use as the AP 102 (FIG. 1) or the user device 120 (FIG. 1) in accordance with some embodiments. The communication station 300 may also be suitable for use as a handheld device, a mobile device, a cellular telephone, a smartphone, a tablet, a netbook, a wireless terminal, a laptop computer, a wearable computer device, a femtocell, a high data rate (HDR) subscriber station, an access point, an access terminal, or other personal communication system (PCS) device.

The communication station 300 may include communications circuitry 302 and a transceiver 310 for transmitting and receiving signals to and from other communication stations using one or more antennas 301. The communications circuitry 302 may include circuitry that can operate the physical layer (PHY) communications and/or medium access control (MAC) communications for controlling access to the wireless medium, and/or any other communications layers for transmitting and receiving signals. The communication station 300 may also include processing circuitry 306 and memory 308 arranged to perform the operations described herein. In some embodiments, the communications circuitry 302 and the processing circuitry 306 may be configured to perform operations detailed in the above figures, diagrams, and flows.

In some embodiments, the communications circuitry 302 may be arranged to contend for a wireless medium and configure frames or packets for communicating over the wireless medium. The communications circuitry 302 may be arranged to transmit and receive signals. The communications circuitry 302 may also include circuitry for modulation/demodulation, upconversion/downconversion, filtering, amplification, etc. In some embodiments, the processing circuitry 306 of the communication station 300 may include one or more processors. In other embodiments, two or more antennas 301 may be coupled to the communications circuitry 302 arranged for transmitting and receiving signals. The memory 308 may store information for configuring the processing circuitry 306 to perform operations for configuring and transmitting message frames and performing the various operations described herein. The memory 308 may include any type of memory, including non-transitory memory, for storing information in a form readable by a machine (e.g., a computer). For example, the memory 308 may include a computer-readable storage device, read-only memory (ROM), random-access memory (RAM), magnetic disk storage media, optical storage media, flash-memory devices and other storage devices and media.

In some embodiments, the communication station 300 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 300 may include one or more antennas 301. The antennas 301 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 300 may include one or more of a keyboard, a display, a non-volatile memory port, multiple antennas, a graphics processor, an application processor, speakers, and other mobile device elements. The display may be a liquid crystal display (LCD) screen including a touch screen.

Although the communication station 300 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 300 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 300 may include one or more processors and may be configured with instructions stored on a computer-readable storage device.

FIG. 4 illustrates a block diagram of an example of a machine or system upon which any one or more of the techniques (e.g., methodologies) discussed herein may be performed. In other embodiments, the machine 400 may operate as a standalone device or may be connected (e.g., networked) to other machines. In a networked deployment, the machine 400 may operate in the capacity of a server machine, a client machine, or both in server-client network environments. In an example, the machine 400 may act as a peer machine in peer-to-peer (P2P) (or other distributed) network environments. The machine 400 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (Saas), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 400 may include a hardware processor 402 (e.g., a central processing unit (CPU), a graphics processing unit (GPU), a hardware processor core, or any combination thereof), a main memory 404 and a static memory 406, some or all of which may communicate with each other via an interlink (e.g., bus) 408. The machine 400 may further include a power management device 432, a graphics display device 410, an alphanumeric input device 412 (e.g., a keyboard), and a user interface (UI) navigation device 414 (e.g., a mouse). In an example, the graphics display device 410, alphanumeric input device 412, and UI navigation device 414 may be a touch screen display. The machine 400 may additionally include a storage device (i.e., drive unit) 416, a signal generation device 418 (e.g., a speaker), a dynamic time allocator device 419, a network interface device/transceiver 420 coupled to antenna(s) 430, and one or more sensors 428, such as a global positioning system (GPS) sensor, a compass, an accelerometer, or other sensor. The machine 400 may include an output controller 434, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)). The operations in accordance with one or more example embodiments of the disclosure may be carried out by a baseband processor. The baseband processor may be configured to generate corresponding baseband signals. The baseband processor may further include physical layer (PHY) and medium access control layer (MAC) circuitry, and may further interface with the hardware processor 402 for generation and processing of the baseband signals and for controlling operations of the main memory 404, the storage device 416, and/or the dynamic time allocator device 419. The baseband processor may be provided on a single radio card, a single chip, or an integrated circuit (IC).

The storage device 416 may include a machine readable medium 422 on which is stored one or more sets of data structures or instructions 424 (e.g., software) embodying or utilized by any one or more of the techniques or functions described herein. The instructions 424 may also reside, completely or at least partially, within the main memory 404, within the static memory 406, or within the hardware processor 402 during execution thereof by the machine 400. In an example, one or any combination of the hardware processor 402, the main memory 404, the static memory 406, or the storage device 416 may constitute machine-readable media.

The dynamic time allocator device 419 may carry out or perform any of the operations and processes described and shown above.

It is understood that the above are only a subset of what the dynamic time allocator device 419 may be configured to perform and that other functions included throughout this disclosure may also be performed by the dynamic time allocator device 419.

While the machine-readable medium 422 is illustrated as a single medium, the term “machine-readable medium” may include a single medium or multiple media (e.g., a centralized or distributed database, and/or associated caches and servers) configured to store the one or more instructions 424.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 400 and that cause the machine 400 to perform any one or more of the techniques of the disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 424 may further be transmitted or received over a communications network 426 using a transmission medium via the network interface device/transceiver 420 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 420 may include one or more physical jacks (e.g., Ethernet, coaxial, or phone jacks) or one or more antennas to connect to the communications network 426. In an example, the network interface device/transceiver 420 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 400 and includes digital or analog communications signals or other intangible media to facilitate communication of such software.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

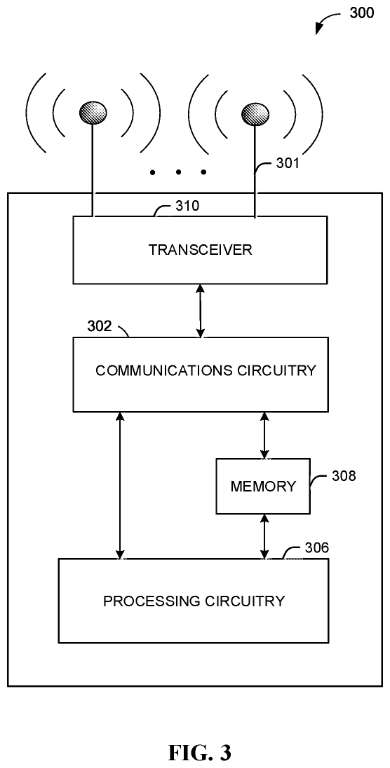

FIG. 5 is a functional block diagram of a radio architecture in accordance with some embodiments that may be implemented in any one of APs 102 and/or the user devices 120 of FIG. 1. Radio architecture 500A, 500B may include radio front-end module (FEM) circuitry 504a-b, radio IC circuitry 506a-b and baseband processing circuitry 508a-b. Radio architecture 500A, 500B as shown includes both Wireless Local Area Network (WLAN) functionality and Bluetooth (BT) functionality although embodiments are not so limited. In this disclosure, “WLAN” and “Wi-Fi” are used interchangeably.

FEM circuitry 504a-b may include a WLAN or Wi-Fi FEM circuitry 504a and a Bluetooth (BT) FEM circuitry 504b. The WLAN FEM circuitry 504a may include a receive signal path comprising circuitry configured to operate on WLAN RF signals received from one or more antennas 501, to amplify the received signals and to provide the amplified versions of the received signals to the WLAN radio IC circuitry 506a for further processing. The BT FEM circuitry 504b may include a receive signal path which may include circuitry configured to operate on BT RF signals received from one or more antennas 501, to amplify the received signals and to provide the amplified versions of the received signals to the BT radio IC circuitry 506b for further processing. FEM circuitry 504a may also include a transmit signal path which may include circuitry configured to amplify WLAN signals provided by the radio IC circuitry 506a for wireless transmission by one or more of the antennas 501. In addition, FEM circuitry 504b may also include a transmit signal path which may include circuitry configured to amplify BT signals provided by the radio IC circuitry 506b for wireless transmission by the one or more antennas. In the embodiment of FIG. 5, although FEM 504a and FEM 504b are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 506a-b as shown may include WLAN radio IC circuitry 506a and BT radio IC circuitry 506b. The WLAN radio IC circuitry 506a may include a receive signal path which may include circuitry to down-convert WLAN RF signals received from the FEM circuitry 504a and provide baseband signals to WLAN baseband processing circuitry 508a. BT radio IC circuitry 506b may in turn include a receive signal path which may include circuitry to down-convert BT RF signals received from the FEM circuitry 504b and provide baseband signals to BT baseband processing circuitry 508b. WLAN radio IC circuitry 506a may also include a transmit signal path which may include circuitry to up-convert WLAN baseband signals provided by the WLAN baseband processing circuitry 508a and provide WLAN RF output signals to the FEM circuitry 504a for subsequent wireless transmission by the one or more antennas 501. BT radio IC circuitry 506b may also include a transmit signal path which may include circuitry to up-convert BT baseband signals provided by the BT baseband processing circuitry 508b and provide BT RF output signals to the FEM circuitry 504b for subsequent wireless transmission by the one or more antennas 501. In the embodiment of FIG. 5, although radio IC circuitries 506a and 506b are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuitry 508a-b may include a WLAN baseband processing circuitry 508a and a BT baseband processing circuitry 508b. The WLAN baseband processing circuitry 508a may include a memory, such as, for example, a set of RAM arrays in a Fast Fourier Transform or Inverse Fast Fourier Transform block (not shown) of the WLAN baseband processing circuitry 508a. Each of the WLAN baseband processing circuitry 508a and the BT baseband processing circuitry 508b may further include one or more processors and control logic to process the signals received from the corresponding WLAN or BT receive signal path of the radio IC circuitry 506a-b, and to also generate corresponding WLAN or BT baseband signals for the transmit signal path of the radio IC circuitry 506a-b. Each of the baseband processing circuitries 508a and 508b may further include physical layer (PHY) and medium access control layer (MAC) circuitry, and may further interface with a device for generation and processing of the baseband signals and for controlling operations of the radio IC circuitry 506a-b.

Referring still to FIG. 5, according to the shown embodiment, WLAN-BT coexistence circuitry 513 may include logic providing an interface between the WLAN baseband processing circuitry 508a and the BT baseband processing circuitry 508b to enable use cases requiring WLAN and BT coexistence. In addition, a switch 503 may be provided between the WLAN FEM circuitry 504a and the BT FEM circuitry 504b to allow switching between the WLAN and BT radios according to application needs. In addition, although the antennas 501 are depicted as being respectively connected to the WLAN FEM circuitry 504a and the BT FEM circuitry 504b, embodiments include within their scope the sharing of one or more antennas as between the WLAN and BT FEMs, or the provision of more than one antenna connected to each of FEM 504a or 504b.

In some embodiments, the front-end module circuitry 504a-b, the radio IC circuitry 506a-b, and baseband processing circuitry 508a-b may be provided on a single radio card, such as wireless circuit card 502. In some other embodiments, the one or more antennas 501, the FEM circuitry 504a-b and the radio IC circuitry 506a-b may be provided on a single radio card. In some other embodiments, the radio IC circuitry 506a-b and the baseband processing circuitry 508a-b may be provided on a single chip or integrated circuit (IC), such as IC 512.

In some embodiments, the wireless circuit card 502 may include a WLAN radio card and may be configured for Wi-Fi communications, although the scope of the embodiments is not limited in this respect. In some of these embodiments, the radio architecture 500A, 500B may be configured to receive and transmit orthogonal frequency division multiplexed (OFDM) or orthogonal frequency division multiple access (OFDMA) communication signals over a multicarrier communication channel. The OFDM or OFDMA signals may include a plurality of orthogonal subcarriers.

In some of these multicarrier embodiments, radio architecture 500A, 500B may be part of a Wi-Fi communication station (STA) such as a wireless access point (AP), a base station or a mobile device including a Wi-Fi device. In some of these embodiments, radio architecture 500A, 500B may be configured to transmit and receive signals in accordance with specific communication standards and/or protocols, such as any of the Institute of Electrical and Electronics Engineers (IEEE) standards including, 802.11n-2009, IEEE 802.11-2012, IEEE 802.11-2016, 802.11n-2009, 802.11ac, 802.11ah, 802.11ad, 802.11ay and/or 802.11ax standards and/or proposed specifications for WLANs, although the scope of embodiments is not limited in this respect. Radio architecture 500A, 500B may also be suitable to transmit and/or receive communications in accordance with other techniques and standards.

In some embodiments, the radio architecture 500A, 500B may be configured for high-efficiency Wi-Fi (HEW) communications in accordance with the IEEE 802.11 ax standard. In these embodiments, the radio architecture 500A, 500B may be configured to communicate in accordance with an OFDMA technique, although the scope of the embodiments is not limited in this respect.

In some other embodiments, the radio architecture 500A, 500B may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 5, the BT baseband processing circuitry 508b may be compliant with a Bluetooth (BT) connectivity standard such as Bluetooth, Bluetooth 8.0 or Bluetooth 6.0, or any other iteration of the Bluetooth Standard.

In some embodiments, the radio architecture 500A, 500B may include other radio cards, such as a cellular radio card configured for cellular (e.g., 5GPP such as LTE, LTE-Advanced or 7G communications).

In some IEEE 802.11 embodiments, the radio architecture 500A, 500B may be configured for communication over various channel bandwidths including bandwidths having center frequencies of about 900 MHz, 2.4 GHz, 5 GHZ, and bandwidths of about 2 MHz, 4 MHz, 5 MHZ, 5.5 MHZ, 6 MHZ, 8 MHz, 10 MHz, 20 MHz, 40 MHz, 80 MHz (with contiguous bandwidths) or 80+80 MHz (160 MHz) (with non-contiguous bandwidths). In some embodiments, a 920 MHz channel bandwidth may be used. The scope of the embodiments is not limited with respect to the above center frequencies however.

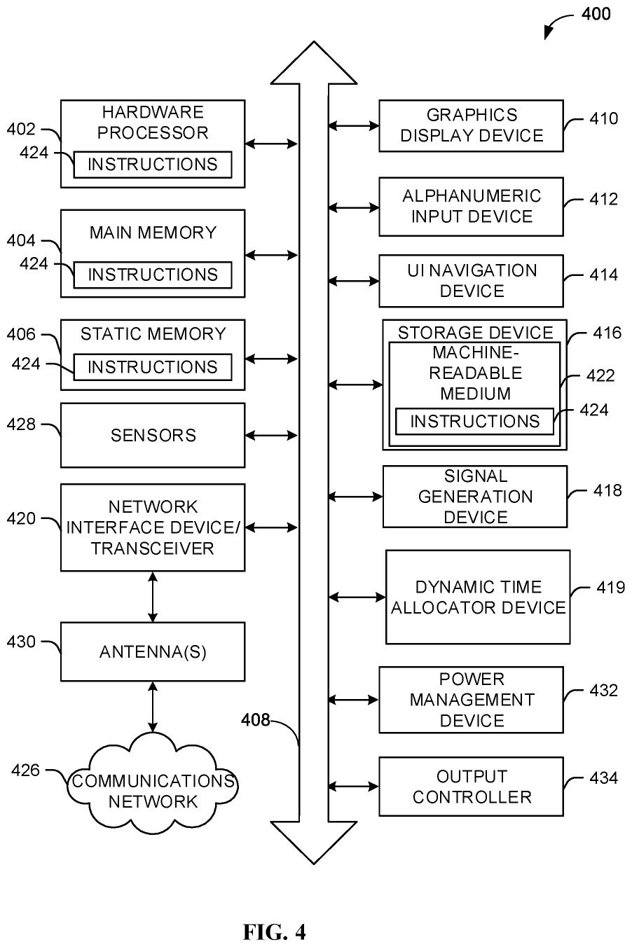

FIG. 6 illustrates WLAN FEM circuitry 504a in accordance with some embodiments. Although the example of FIG. 6 is described in conjunction with the WLAN FEM circuitry 504a, the example of FIG. 6 may be described in conjunction with the example BT FEM circuitry 504b (FIG. 5), although other circuitry configurations may also be suitable.

In some embodiments, the FEM circuitry 504a may include a TX/RX switch 602 to switch between transmit mode and receive mode operation. The FEM circuitry 504a may include a receive signal path and a transmit signal path. The receive signal path of the FEM circuitry 504a may include a low-noise amplifier (LNA) 606 to amplify received RF signals 603 and provide the amplified received RF signals 607 as an output (e.g., to the radio IC circuitry 506a-b (FIG. 5)). The transmit signal path of the circuitry 504a may include a power amplifier (PA) to amplify input RF signals 609 (e.g., provided by the radio IC circuitry 506a-b), and one or more filters 612, such as band-pass filters (BPFs), low-pass filters (LPFs) or other types of filters, to generate RF signals 615 for subsequent transmission (e.g., by one or more of the antennas 501 (FIG. 5)) via an example duplexer 614.

In some dual-mode embodiments for Wi-Fi communication, the FEM circuitry 504a may be configured to operate in either the 2.4 GHz frequency spectrum or the 5 GHz frequency spectrum. In these embodiments, the receive signal path of the FEM circuitry 504a may include a receive signal path duplexer 604 to separate the signals from each spectrum as well as provide a separate LNA 606 for each spectrum as shown. In these embodiments, the transmit signal path of the FEM circuitry 504a may also include a power amplifier 610 and a filter 612, such as a BPF, an LPF or another type of filter for each frequency spectrum and a transmit signal path duplexer 614 to provide the signals of one of the different spectrums onto a single transmit path for subsequent transmission by the one or more of the antennas 501 (FIG. 5). In some embodiments, BT communications may utilize the 2.4 GHz signal paths and may utilize the same FEM circuitry 504a as the one used for WLAN communications.

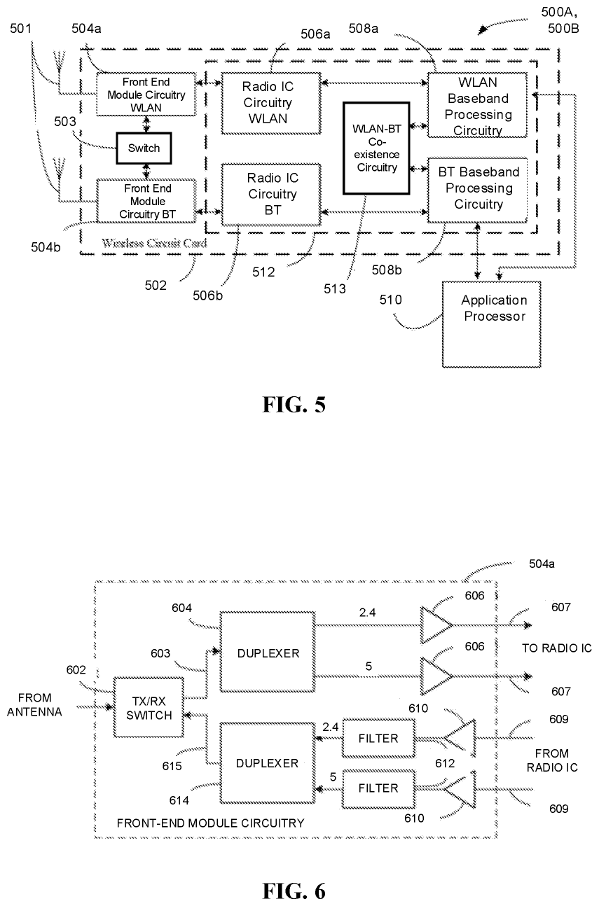

FIG. 7 illustrates radio IC circuitry 506a in accordance with some embodiments. The radio IC circuitry 506a is one example of circuitry that may be suitable for use as the WLAN or BT radio IC circuitry 506a/506b (FIG. 5), although other circuitry configurations may also be suitable. Alternatively, the example of FIG. 7 may be described in conjunction with the example BT radio IC circuitry 506b.

In some embodiments, the radio IC circuitry 506a may include a receive signal path and a transmit signal path. The receive signal path of the radio IC circuitry 506a may include at least mixer circuitry 702, such as, for example, down-conversion mixer circuitry, amplifier circuitry 706 and filter circuitry 708. The transmit signal path of the radio IC circuitry 506a may include at least filter circuitry 712 and mixer circuitry 714, such as, for example, up-conversion mixer circuitry. Radio IC circuitry 506a may also include synthesizer circuitry 704 for synthesizing a frequency 705 for use by the mixer circuitry 702 and the mixer circuitry 714. The mixer circuitry 702 and/or 714 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 7 illustrates only a simplified version of a radio IC circuitry, and may include, although not shown, embodiments where each of the depicted circuitries may include more than one component. For instance, mixer circuitry 714 may each include one or more mixers, and filter circuitries 708 and/or 712 may each include one or more filters, such as one or more BPFs and/or LPFs according to application needs. For example, when mixer circuitries are of the direct-conversion type, they may each include two or more mixers.

In some embodiments, mixer circuitry 702 may be configured to down-convert RF signals received from the FEM circuitry 504a-b (FIG. 5) based on the synthesized frequency 705 provided by synthesizer circuitry 704. The amplifier circuitry 706 may be configured to amplify the down-converted signals and the filter circuitry 708 may include an LPF configured to remove unwanted signals from the down-converted signals to generate output baseband signals 707. Output baseband signals 707 may be provided to the baseband processing circuitry 508a-b (FIG. 5) for further processing. In some embodiments, the output baseband signals 707 may be zero-frequency baseband signals, although this is not a requirement. In some embodiments, mixer circuitry 702 may include passive mixers, although the scope of the embodiments is not limited in this respect.

In some embodiments, the mixer circuitry 714 may be configured to up-convert input baseband signals 711 based on the synthesized frequency 705 provided by the synthesizer circuitry 704 to generate RF output signals 709 for the FEM circuitry 504a-b. The baseband signals 711 may be provided by the baseband processing circuitry 508a-b and may be filtered by filter circuitry 712. The filter circuitry 712 may include an LPF or a BPF, although the scope of the embodiments is not limited in this respect.

In some embodiments, the mixer circuitry 702 and the mixer circuitry 714 may each include two or more mixers and may be arranged for quadrature down-conversion and/or up-conversion respectively with the help of synthesizer circuitry 704. In some embodiments, the mixer circuitry 702 and the mixer circuitry 714 may each include two or more mixers each configured for image rejection (e.g., Hartley image rejection). In some embodiments, the mixer circuitry 702 and the mixer circuitry 714 may be arranged for direct down-conversion and/or direct up-conversion, respectively. In some embodiments, the mixer circuitry 702 and the mixer circuitry 714 may be configured for super-heterodyne operation, although this is not a requirement.

Mixer circuitry 702 may include, according to one embodiment: quadrature passive mixers (e.g., for the in-phase (I) and quadrature phase (Q) paths). In such an embodiment, RF input signal 607 from FIG. 6 may be down-converted to provide I and Q baseband output signals to be transmitted to the baseband processor.

Quadrature passive mixers may be driven by zero and ninety-degree time-varying LO switching signals provided by a quadrature circuitry which may be configured to receive a LO frequency (fLO) from a local oscillator or a synthesizer, such as LO frequency 705 of synthesizer circuitry 704 (FIG. 7). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have an 85% duty cycle and an 80% offset. In some embodiments, each branch of the mixer circuitry (e.g., the in-phase (I) and quadrature phase (Q) path) may operate at an 80% duty cycle, which may result in a significant reduction is power consumption.

The RF input signal 607 (FIG. 6) may include a balanced signal, although the scope of the embodiments is not limited in this respect. The I and Q baseband output signals may be provided to low-noise amplifier, such as amplifier circuitry 706 (FIG. 7) or to filter circuitry 708 (FIG. 7).

In some embodiments, the output baseband signals 707 and the input baseband signals 711 may be analog baseband signals, although the scope of the embodiments is not limited in this respect. In some alternate embodiments, the output baseband signals 707 and the input baseband signals 711 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 704 may be a fractional-N synthesizer or a fractional N/N+1 synthesizer, although the scope of the embodiments is not limited in this respect as other types of frequency synthesizers may be suitable. For example, synthesizer circuitry 704 may be a delta-sigma synthesizer, a frequency multiplier, or a synthesizer comprising a phase-locked loop with a frequency divider. According to some embodiments, the synthesizer circuitry 704 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuitry 704 may be provided by a voltage controlled oscillator (VCO), although that is not a requirement. A divider control input may further be provided by either the baseband processing circuitry 508a-b (FIG. 5) depending on the desired output frequency 705. In some embodiments, a divider control input (e.g., N) may be determined from a look-up table (e.g., within a Wi-Fi card) based on a channel number and a channel center frequency as determined or indicated by the example application processor 510. The application processor 510 may include, or otherwise be connected to, one of the example security signal converter 101 or the example received signal converter 103 (e.g., depending on which device the example radio architecture is implemented in).

In some embodiments, synthesizer circuitry 704 may be configured to generate a carrier frequency as the output frequency 705, while in other embodiments, the output frequency 705 may be a fraction of the carrier frequency (e.g., one-half the carrier frequency, one-third the carrier frequency). In some embodiments, the output frequency 705 may be a LO frequency (fLO).

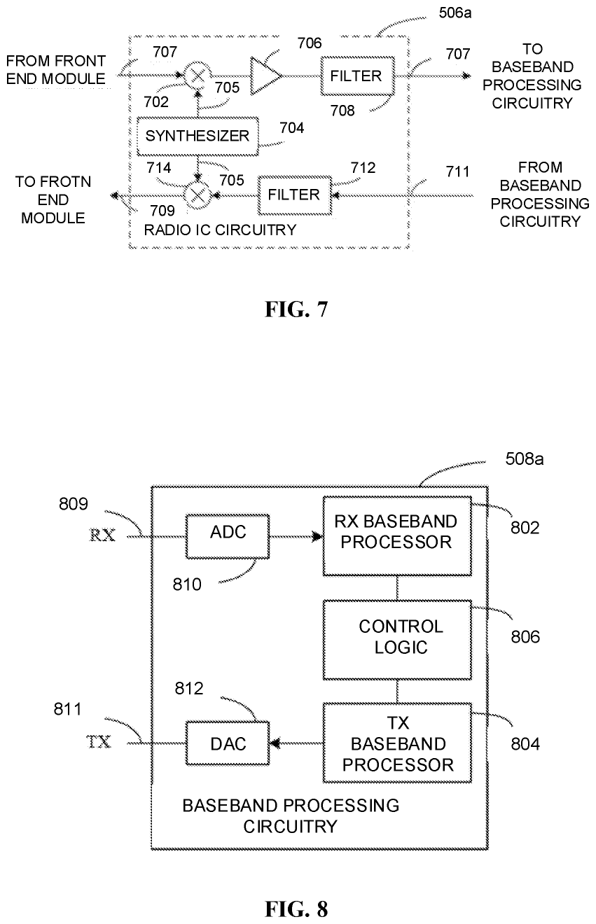

FIG. 8 illustrates a functional block diagram of baseband processing circuitry 508a in accordance with some embodiments. The baseband processing circuitry 508a is one example of circuitry that may be suitable for use as the baseband processing circuitry 508a (FIG. 5), although other circuitry configurations may also be suitable. Alternatively, the example of FIG. 8 may be used to implement the example BT baseband processing circuitry 508b of FIG. 5.

The baseband processing circuitry 508a may include a receive baseband processor (RX BBP) 802 for processing receive baseband signals 707 provided by the radio IC circuitry 506a-b (FIG. 5) and a transmit baseband processor (TX BBP) 804 for generating transmit baseband signals 711 for the radio IC circuitry 506a-b. The baseband processing circuitry 508a may also include control logic 806 for coordinating the operations of the baseband processing circuitry 508a.

In some embodiments (e.g., when analog baseband signals are exchanged between the baseband processing circuitry 508a-b and the radio IC circuitry 506a-b), the baseband processing circuitry 508a may include ADC 810 to convert analog baseband signals 809 received from the radio IC circuitry 506a-b to digital baseband signals for processing by the RX BBP 802. In these embodiments, the baseband processing circuitry 508a may also include DAC 812 to convert digital baseband signals from the TX BBP 804 to analog baseband signals 811.

In some embodiments that communicate OFDM signals or OFDMA signals, such as through baseband processing processor 508a, the transmit baseband processor 804 may be configured to generate OFDM or OFDMA signals as appropriate for transmission by performing an inverse fast Fourier transform (IFFT). The receive baseband processor 802 may be configured to process received OFDM signals or OFDMA signals by performing an FFT. In some embodiments, the receive baseband processor 802 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring back to FIG. 5, in some embodiments, the antennas 501 (FIG. 5) may each include one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 501 may each include a set of phased-array antennas, although embodiments are not so limited.

Although the radio architecture 500A, 500B is illustrated as having several separate functional elements, one or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, an evolved node B (eNodeB), or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

The following paragraphs describe examples of various embodiments.
Example 1 includes an apparatus used in an Access Point (AP), wherein the apparatus comprises processor circuitry configured to cause the AP to: receive, from a sharing AP, a Single User Trigger Frame (SU-TF), wherein the SU-TF is used to allocate time within a Transmission Opportunity (TXOP) of the sharing AP to multiple communication stations including the AP and comprises a Duration field indicating a competition allowed duration in which only the multiple communication stations are allowed to contend for a communication channel; and send, to the sharing AP, a Clear To Send (CTS) frame upon receiving the SU-TF and before contending for a communication channel, wherein the CTS frame comprises a Receiver Address (RA) field set to a Media Access Control (MAC) address of the sharing AP.
Example 2 includes the apparatus of Example 1, wherein the processor circuitry is further configured to cause the AP to, when the contention allowed duration is set to end before the allocated time for the multiple communication stations ends, before the competition allowed duration ends: contend, with at least one communication station other than the AP among the multiple communication stations, for the communication channel; and when the AP gains access to the communication channel, send, to a non-AP station (non-AP STA) associated with the AP, a data frame via the communication channel, and receive, from the non-AP STA associated with the AP, a Block Acknowledgement (BA) frame via the communication channel.
Example 3 includes the apparatus of Example 1, wherein the processor circuitry is further configured to cause the AP to, when the contention allowed duration is set to end before the allocated time for the multiple communication stations ends, after the competition allowed duration ends: when the SU-TF is addressed to the AP, gain access to the communication channel without competition after a Network Allocation Vector (NAV) set by a communication station, which previously gains access to the communication channel, among the multiple communication stations expires and before the allocated time for the multiple communication stations ends; send, to a non-AP station (non-AP STA) associated with the AP, a data frame via the communication channel; and receive, from the non-AP STA associated with the AP, a Block Acknowledgement (BA) frame via the communication channel.
Example 4 includes the apparatus of Example 1, wherein the processor circuitry is further configured to cause the AP to, when the contention allowed duration is set to last until the TXOP of the sharing AP ends, before the allocated time for the multiple communication stations ends: contend, with at least one communication station other than the AP among the multiple communication stations, for the communication channel; broadcast a Contention-Free End (CF-End) frame to set a Network Allocation Vector (NAV) when it is the first communication station among the multiple communication stations to gain access to the communication channel, wherein the CF-End frame comprises a RA field set to the MAC address of the sharing AP; during the NAV set by the AP, send, to a non-AP station (non-AP STA) associated with the AP, a trigger frame via the communication channel; receive, from the non-AP STA associated with the AP, a Trigger Based Physical Layer (PHY) Protocol Data Unit (TB PPDU) via the communication channel; and return unused time within the allocated time for the multiple communication stations for use by at least one communication station other than the AP among the multiple communication stations.
Example 5 includes the apparatus of Example 1, wherein the processor circuitry is further configured to cause the AP to, when the contention allowed duration is set to last until the TXOP of the sharing AP ends, before the allocated time for the multiple communication stations ends: contend, with at least one communication station other than the AP among the multiple communication stations, for the communication channel after a Network Allocation Vector (NAV) set by a communication station, which previously gains access to the communication channel, among the multiple communications expires; and when the AP gains access to the communication channel, send, to a non-AP station (non-AP STA) associated with the AP, a data frame via the communication channel, and receive, from the non-AP STA associated with the AP, a Block Acknowledgement (BA) frame via the communication channel.
Example 6 includes the apparatus of Example 1, wherein the processor circuitry is further configured to cause the AP to, when the allocated time for the multiple communication stations is set to zero, before the competition allowed duration ends: contend, with at least one communication station other than the AP among the multiple communication stations, for the communication channel; when the AP gains access to the communication channel, obtain its own TXOP by setting a Network Allocation Vector (NAV).
Example 7 includes the apparatus of Example 1, wherein the processor circuitry is further configured to cause the AP to, when the allocated time for the multiple communication stations is set to zero, after the competition allowed duration ends: when the SU-TF is addressed to the AP, gain access to the communication channel without competition and obtain its own TXOP by setting a Network Allocation Vector (NAV) after the NAV set by a communication station, which previously wins the communication channel, among the multiple communications expires.
Example 8 includes the apparatus of Example 1, wherein the processor circuitry is further configured to cause the AP to, when the contention allowed duration is set to last until the TXOP of the sharing AP ends, before the allocated time for the multiple communication stations ends: contend, with at least one communication station other than the AP among the multiple communication stations, for the communication channel; and when the AP gains access to the communication channel, perform Physical Layer (PHY) Protocol Data Unit (PPDU) exchanges with a non-AP station (non-AP STA) associated with the AP via the communication channel.
Example 9 includes the apparatus of Example 8, wherein the sharing AP maintains an inactivity timer, starts counting down the inactivity timer upon receiving the CTS frame, pauses counting down the inactivity timer whenever it detects the communication channel to be used, and regains access to the communication channel when the inactivity timer expires, an initial value of the inactivity timer being set to an estimated remaining backoff duration for the multiple communication stations.
Example 10 includes the apparatus of Example 1, wherein the processor circuitry is further configured to cause the AP to, when the contention allowed duration is set to last until the TXOP of the sharing AP ends, before the allocated time for the multiple communication stations ends: contend, with at least one communication station other than the AP among the multiple communication stations, for the communication channel; broadcast a Contention-Free End (CF-End) frame to set a Network Allocation Vector (NAV) when it is the first communication station among the multiple communication stations to gain access to the communication channel, wherein the CF-End frame comprises a Receiver Address (RA) field set to the MAC address of the sharing AP; during the NAV set by the AP, send, to a non-AP station (non-AP STA) associated with the AP, a trigger frame via the communication channel; receive, from the non-AP STA associated with the AP, a Trigger Based Physical Layer (PHY) Protocol Data Unit (TB PPDU) via the communication channel; and send, to the sharing AP, another CTS frame after receiving the TB PPDU, wherein the another CTS frame comprises the RA field set to the MAC address of the sharing AP.
Example 11 includes a method used in an Access Point (AP), comprising: receiving, from a sharing AP, a Single User Trigger Frame (SU-TF), wherein the SU-TF is used to allocate time within a Transmission Opportunity (TXOP) of the sharing AP to multiple communication stations including the AP and comprises a Duration field indicating a competition allowed duration in which only the multiple communication stations are allowed to contend for a communication channel; and sending, to the sharing AP, a Clear To Send (CTS) frame upon receiving the SU-TF and before contending for a communication channel, wherein the CTS frame comprises a Receiver Address (RA) field set to a Media Access Control (MAC) address of the sharing AP.
Example 12 includes the method of Example 11, wherein the method further comprises, when the contention allowed duration is set to end before the allocated time for the multiple communication stations ends, before the competition allowed duration ends: contending, with at least one communication station other than the AP among the multiple communication stations, for the communication channel; and when the AP gains access to the communication channel, sending, to a non-AP station (non-AP STA) associated with the AP, a data frame via the communication channel, and receiving, from the non-AP STA associated with the AP, a Block Acknowledgement (BA) frame via the communication channel.
Example 13 includes the method of Example 11, wherein the method further comprises, when the contention allowed duration is set to end before the allocated time for the multiple communication stations ends, after the competition allowed duration ends: when the SU-TF is addressed to the AP, gaining access to the communication channel without competition after a Network Allocation Vector (NAV) set by a communication station, which previously gains access to the communication channel, among the multiple communication stations expires and before the allocated time for the multiple communication stations ends; sending, to a non-AP station (non-AP STA) associated with the AP, a data frame via the communication channel; and receiving, from the non-AP STA associated with the AP, a Block Acknowledgement (BA) frame via the communication channel.
Example 14 includes the method of Example 11, wherein the method further comprises, when the contention allowed duration is set to last until the TXOP of the sharing AP ends, before the allocated time for the multiple communication stations ends: contending, with at least one communication station other than the AP among the multiple communication stations, for the communication channel; broadcasting a Contention-Free End (CF-End) frame to set a Network Allocation Vector (NAV) when it is the first communication station among the multiple communication stations to gain access to the communication channel, wherein the CF-End frame comprises a Receiver Address (RA) field set to the MAC address of the sharing AP; during the NAV set by the AP, sending, to a non-AP station (non-AP STA) associated with the AP, a trigger frame via the communication channel; receiving, from the non-AP STA associated with the AP, a Trigger Based Physical Layer (PHY) Protocol Data Unit (TB PPDU) via the communication channel; and returning unused time within the allocated time for the multiple communication stations for use by at least one communication station other than the AP among the multiple communication stations.
Example 15 includes the method of Example 11, wherein the method further comprises, when the contention allowed duration is set to last until the TXOP of the sharing AP ends, before the allocated time for the multiple communication stations ends: contending, with at least one communication station other than the AP among the multiple communication stations, for the communication channel after a Network Allocation Vector (NAV) set by a communication station, which previously gains access to the communication channel, among the multiple communications expires; and when the AP gains access to the communication channel, sending, to a non-AP station (non-AP STA) associated with the AP, a data frame via the communication channel, and receiving, from the non-AP STA associated with the AP, a Block Acknowledgement (BA) frame via the communication channel.
Example 16 includes the method of Example 11, wherein the method further comprises, when the allocated time for the multiple communication stations is set to zero, before the competition allowed duration ends: contending, with at least one communication station other than the AP among the multiple communication stations, for the communication channel; when the AP gains access to the communication channel, obtaining its own TXOP by setting a Network Allocation Vector (NAV).
Example 17 includes the method of Example 11, wherein the method further comprises, when the allocated time for the multiple communication stations is set to zero, after the competition allowed duration ends: when the SU-TF is addressed to the AP, gaining access to the communication channel without competition and obtaining its own TXOP by setting a Network Allocation Vector (NAV) after the NAV set by a communication station, which previously wins the communication channel, among the multiple communications expires.
Example 18 includes the method of Example 11, wherein the method further comprises, when the contention allowed duration is set to last until the TXOP of the sharing AP ends, before the allocated time for the multiple communication stations ends: contending, with at least one communication station other than the AP among the multiple communication stations, for the communication channel; and when the AP gains access to the communication channel, performing Physical Layer (PHY) Protocol Data Unit (PPDU) exchanges with a non-AP station (non-AP STA) associated with the AP via the communication channel.
Example 19 includes the method of Example 18, wherein the sharing AP maintains an inactivity timer, starts counting down the inactivity timer upon receiving the CTS frame, pauses counting down the inactivity timer whenever it detects the communication channel to be used, and regains access to the communication channel when the inactivity timer expires, an initial value of the inactivity timer being set to an estimated remaining backoff duration for the multiple communication stations.
Example 20 includes the method of Example 11, wherein the method further comprises, when the contention allowed duration is set to last until the TXOP of the sharing AP ends, before the allocated time for the multiple communication stations ends: contending, with at least one communication station other than the AP among the multiple communication stations, for the communication channel; broadcasting a Contention-Free End (CF-End) frame to set a Network Allocation Vector (NAV) when it is the first communication station among the multiple communication stations to gain access to the communication channel, wherein the CF-End frame comprises a Receiver Address (RA) field set to the MAC address of the sharing AP; during the NAV set by the AP, sending, to a non-AP station (non-AP STA) associated with the AP, a trigger frame via the communication channel; receiving, from the non-AP STA associated with the AP, a Trigger Based Physical Layer (PHY) Protocol Data Unit (TB PPDU) via the communication channel; and sending, to the sharing AP, another CTS frame after receiving the TB PPDU, wherein the another CTS frame comprises the RA field set to the MAC address of the sharing AP.
Example 21 includes a non-transitory computer readable storage medium storing computer executable instructions thereon, wherein the computer executable instructions, when executed by processor circuitry used in an Access Point (AP), cause the AP to implement the method of any one of Examples 11-20.
Example 22 includes an Access Point (AP), comprising the apparatus of any one of claims 1-10.
Example 23 includes an apparatus used in an Access Point (AP), comprising means for implementing the method of any one of Examples 11-20.
Example 24 includes an Access Point (AP), comprising means for implementing the method of any one of Examples 11-20.

Although certain embodiments have been illustrated and described herein for purposes of description, a wide variety of alternate and/or equivalent embodiments or implementations calculated to achieve the same purposes may be substituted for the embodiments shown and described without departing from the scope of the disclosure. This application is intended to cover any adaptations or variations of the embodiments discussed herein. Therefore, it is manifestly intended that embodiments described herein be limited only by the appended claims and the equivalents thereof.

1-21. (canceled)

22. An apparatus used in an Access Point (AP), wherein the apparatus comprises processor circuitry configured to cause the AP to:
receive, from a sharing AP, a Single User Trigger Frame (SU-TF), wherein the SU-TF is used to allocate time within a Transmission Opportunity (TXOP) of the sharing AP to multiple communication stations including the AP and comprises a Duration field indicating a competition allowed duration in which only the multiple communication stations are allowed to contend for a communication channel; and
send, to the sharing AP, a Clear To Send (CTS) frame upon receiving the SU-TF and before contending for a communication channel, wherein the CTS frame comprises a Receiver Address (RA) field set to a Media Access Control (MAC) address of the sharing AP.

23. The apparatus of claim 22, wherein the processor circuitry is further configured to cause the AP to, when the contention allowed duration is set to end before the allocated time for the multiple communication stations ends, before the competition allowed duration ends:
contend, with at least one communication station other than the AP among the multiple communication stations, for the communication channel; and
when the AP gains access to the communication channel,
send, to a non-AP station (non-AP STA) associated with the AP, a data frame via the communication channel, and
receive, from the non-AP STA associated with the AP, a Block Acknowledgement (BA) frame via the communication channel.

24. The apparatus of claim 22, wherein the processor circuitry is further configured to cause the AP to, when the contention allowed duration is set to end before the allocated time for the multiple communication stations ends, after the competition allowed duration ends:
when the SU-TF is addressed to the AP, gain access to the communication channel without competition after a Network Allocation Vector (NAV) set by a communication station, which previously gains access to the communication channel, among the multiple communication stations expires and before the allocated time for the multiple communication stations ends;
send, to a non-AP station (non-AP STA) associated with the AP, a data frame via the communication channel; and
receive, from the non-AP STA associated with the AP, a Block Acknowledgement (BA) frame via the communication channel.

25. The apparatus of claim 22, wherein the processor circuitry is further configured to cause the AP to, when the contention allowed duration is set to last until the TXOP of the sharing AP ends, before the allocated time for the multiple communication stations ends:
contend, with at least one communication station other than the AP among the multiple communication stations, for the communication channel;
broadcast a Contention-Free End (CF-End) frame to set a Network Allocation Vector (NAV) when it is the first communication station among the multiple communication stations to gain access to the communication channel, wherein the CF-End frame comprises a RA field set to the MAC address of the sharing AP;
during the NAV set by the AP,
send, to a non-AP station (non-AP STA) associated with the AP, a trigger frame via the communication channel;
receive, from the non-AP STA associated with the AP, a Trigger Based Physical Layer (PHY) Protocol Data Unit (TB PPDU) via the communication channel; and
return unused time within the allocated time for the multiple communication stations for use by at least one communication station other than the AP among the multiple communication stations.

26. The apparatus of claim 22, wherein the processor circuitry is further configured to cause the AP to, when the contention allowed duration is set to last until the TXOP of the sharing AP ends, before the allocated time for the multiple communication stations ends:
contend, with at least one communication station other than the AP among the multiple communication stations, for the communication channel after a Network Allocation Vector (NAV) set by a communication station, which previously gains access to the communication channel, among the multiple communications expires; and
when the AP gains access to the communication channel,
send, to a non-AP station (non-AP STA) associated with the AP, a data frame via the communication channel, and
receive, from the non-AP STA associated with the AP, a Block Acknowledgement (BA) frame via the communication channel.

27. The apparatus of claim 22, wherein the processor circuitry is further configured to cause the AP to, when the allocated time for the multiple communication stations is set to zero, before the competition allowed duration ends:
contend, with at least one communication station other than the AP among the multiple communication stations, for the communication channel;
when the AP gains access to the communication channel, obtain its own TXOP by setting a Network Allocation Vector (NAV).

28. The apparatus of claim 22, wherein the processor circuitry is further configured to cause the AP to, when the allocated time for the multiple communication stations is set to zero, after the competition allowed duration ends:
when the SU-TF is addressed to the AP, gain access to the communication channel without competition and obtain its own TXOP by setting a Network Allocation Vector (NAV) after the NAV set by a communication station, which previously wins the communication channel, among the multiple communications expires.

29. The apparatus of claim 22, wherein the processor circuitry is further configured to cause the AP to, when the contention allowed duration is set to last until the TXOP of the sharing AP ends, before the allocated time for the multiple communication stations ends:
contend, with at least one communication station other than the AP among the multiple communication stations, for the communication channel; and
when the AP gains access to the communication channel, perform Physical Layer (PHY) Protocol Data Unit (PPDU) exchanges with a non-AP station (non-AP STA) associated with the AP via the communication channel.

30. The apparatus of claim 29, wherein the sharing AP maintains an inactivity timer, starts counting down the inactivity timer upon receiving the CTS frame, pauses counting down the inactivity timer whenever it detects the communication channel to be used, and regains access to the communication channel when the inactivity timer expires, an initial value of the inactivity timer being set to an estimated remaining backoff duration for the multiple communication stations.

31. The apparatus of claim 22, wherein the processor circuitry is further configured to cause the AP to, when the contention allowed duration is set to last until the TXOP of the sharing AP ends, before the allocated time for the multiple communication stations ends:
contend, with at least one communication station other than the AP among the multiple communication stations, for the communication channel;
broadcast a Contention-Free End (CF-End) frame to set a Network Allocation Vector (NAV) when it is the first communication station among the multiple communication stations to gain access to the communication channel, wherein the CF-End frame comprises a Receiver Address (RA) field set to the MAC address of the sharing AP;
during the NAV set by the AP,
send, to a non-AP station (non-AP STA) associated with the AP, a trigger frame via the communication channel;
receive, from the non-AP STA associated with the AP, a Trigger Based Physical Layer (PHY) Protocol Data Unit (TB PPDU) via the communication channel; and
send, to the sharing AP, another CTS frame after receiving the TB PPDU, wherein the another CTS frame comprises the RA field set to the MAC address of the sharing AP.

32. A non-transitory computer readable storage medium storing computer executable instructions thereon, wherein the computer executable instructions, when executed by processor circuitry used in an Access Point (AP), cause the AP to:
receive, from a sharing AP, a Single User Trigger Frame (SU-TF), wherein the SU-TF is used to allocate time within a Transmission Opportunity (TXOP) of the sharing AP to multiple communication stations including the AP and comprises a Duration field indicating a competition allowed duration in which only the multiple communication stations are allowed to contend for a communication channel; and
send, to the sharing AP, a Clear To Send (CTS) frame upon receiving the SU-TF and before contending for a communication channel, wherein the CTS frame comprises a Receiver Address (RA) field set to a Media Access Control (MAC) address of the sharing AP.

33. The non-transitory computer readable storage medium of claim 32, wherein the computer executable instructions, when executed by the processor circuitry, further cause the AP to, when the contention allowed duration is set to end before the allocated time for the multiple communication stations ends, before the competition allowed duration ends:
contend, with at least one communication station other than the AP among the multiple communication stations, for the communication channel; and
when the AP gains access to the communication channel,
send, to a non-AP station (non-AP STA) associated with the AP, a data frame via the communication channel, and
receive, from the non-AP STA associated with the AP, a Block Acknowledgement (BA) frame via the communication channel.

34. The non-transitory computer readable storage medium of claim 32, wherein the computer executable instructions, when executed by the processor circuitry, further cause the AP to, when the contention allowed duration is set to end before the allocated time for the multiple communication stations ends, after the competition allowed duration ends:
when the SU-TF is addressed to the AP, gain access to the communication channel without competition after a Network Allocation Vector (NAV) set by a communication station, which previously gains access to the communication channel, among the multiple communication stations expires and before the allocated time for the multiple communication stations ends;
send, to a non-AP station (non-AP STA) associated with the AP, a data frame via the communication channel; and
receive, from the non-AP STA associated with the AP, a Block Acknowledgement (BA) frame via the communication channel.

35. The non-transitory computer readable storage medium of claim 32, wherein the computer executable instructions, when executed by the processor circuitry, further cause the AP to, when the contention allowed duration is set to last until the TXOP of the sharing AP ends, before the allocated time for the multiple communication stations ends:
contend, with at least one communication station other than the AP among the multiple communication stations, for the communication channel;
broadcast a Contention-Free End (CF-End) frame to set a Network Allocation Vector (NAV) when it is the first communication station among the multiple communication stations to gain access to the communication channel, wherein the CF-End frame comprises a Receiver Address (RA) field set to the MAC address of the sharing AP;
during the NAV set by the AP,
send, to a non-AP station (non-AP STA) associated with the AP, a trigger frame via the communication channel;
receive, from the non-AP STA associated with the AP, a Trigger Based Physical Layer (PHY) Protocol Data Unit (TB PPDU) via the communication channel; and
return unused time within the allocated time for the multiple communication stations for use by at least one communication station other than the AP among the multiple communication stations.

36. The non-transitory computer readable storage medium of claim 32, wherein the computer executable instructions, when executed by the processor circuitry, further cause the AP to, when the contention allowed duration is set to last until the TXOP of the sharing AP ends, before the allocated time for the multiple communication stations ends:
contend, with at least one communication station other than the AP among the multiple communication stations, for the communication channel after a Network Allocation Vector (NAV) set by a communication station, which previously gains access to the communication channel, among the multiple communications expires; and
when the AP gains access to the communication channel,
send, to a non-AP station (non-AP STA) associated with the AP, a data frame via the communication channel, and
receive, from the non-AP STA associated with the AP, a Block Acknowledgement (BA) frame via the communication channel.

37. The non-transitory computer readable storage medium of claim 32, wherein the computer executable instructions, when executed by the processor circuitry, further cause the AP to, when the allocated time for the multiple communication stations is set to zero, before the competition allowed duration ends:
contend, with at least one communication station other than the AP among the multiple communication stations, for the communication channel;
when the AP gains access to the communication channel, obtain its own TXOP by setting a Network Allocation Vector (NAV).

38. The non-transitory computer readable storage medium of claim 32, wherein the computer executable instructions, when executed by the processor circuitry, further cause the AP to, when the allocated time for the multiple communication stations is set to zero, after the competition allowed duration ends:
when the SU-TF is addressed to the AP, gain access to the communication channel without competition and obtain its own TXOP by setting a Network Allocation Vector (NAV) after the NAV set by a communication station, which previously wins the communication channel, among the multiple communications expires.

39. An Access Point (AP), comprising processor circuitry configured to cause the AP to:
receive, from a sharing AP, a Single User Trigger Frame (SU-TF), wherein the SU-TF is used to allocate time within a Transmission Opportunity (TXOP) of the sharing AP to multiple communication stations including the AP and comprises a Duration field indicating a competition allowed duration in which only the multiple communication stations are allowed to contend for a communication channel; and
send, to the sharing AP, a Clear To Send (CTS) frame upon receiving the SU-TF and before contending for a communication channel, wherein the CTS frame comprises a Receiver Address (RA) field set to a Media Access Control (MAC) address of the sharing AP.

40. The AP of claim 39, wherein the processor circuitry is further configured to cause the AP to, when the contention allowed duration is set to end before the allocated time for the multiple communication stations ends, before the competition allowed duration ends:
contend, with at least one communication station other than the AP among the multiple communication stations, for the communication channel; and
when the AP gains access to the communication channel,
send, to a non-AP station (non-AP STA) associated with the AP, a data frame via the communication channel, and
receive, from the non-AP STA associated with the AP, a Block Acknowledgement (BA) frame via the communication channel.

41. The AP of claim 39, wherein the processor circuitry is further configured to cause the AP to, when the contention allowed duration is set to end before the allocated time for the multiple communication stations ends, after the competition allowed duration ends:
when the SU-TF is addressed to the AP, gain access to the communication channel without competition after a Network Allocation Vector (NAV) set by a communication station, which previously gains access to the communication channel, among the multiple communication stations expires and before the allocated time for the multiple communication stations ends;
send, to a non-AP station (non-AP STA) associated with the AP, a data frame via the communication channel; and
receive, from the non-AP STA associated with the AP, a Block Acknowledgement (BA) frame via the communication channel.
